(19) United States
(12) Patent Application Publication
(10) Pub. No.: US 2006/0080911 A1
(43) Pub. Date: Apr. 20, 2006

(54) Mounting unit for a window or a door

(76) Inventors: Bernd Diekmann, Halle (DE); Frank Nolte, Osnabruck (DE); Eitel-Friedrich Hocker, Bielefeld (DE)

Correspondence Address: BARNES & THORNBURG, 750-17TH STREET NW, SUITE 900, WASHINGTON, DC, 20006, US

(21) Appl. No.: 10/541,463

(22) PCT Filed: Dec. 10, 2003
(86) PCT No.: PCT/EP03/13992

§ 371 Date: Jul. 6, 2005

(30) Foreign Application Priority Data
Jan. 10, 2003 (DE) 103 00 847.0

(51) Int. Cl. E06B 1/04; E06B 3/988

(52) U.S. Cl. 52/204.1; 52/204.72

(57) ABSTRACT

A mounting unit for a window or a door including a frame and a leaf mounted on the frame. The leaf is movable from a closed position by at least one curved guiding mechanism into a parallel knockout position and the leaf is pivotable from the parallel knockout position about a vertical axis into a rotary opening position. At least one upper horizontal guiding mechanism is provided on a top side of the leaf and at least one lower horizontal guiding mechanism is provided on a bottom side of the leaf to guide the leaf. In a closed position of the leaf, the at least one upper and the at least one lower horizontal guiding mechanisms are arranged inside the frame. The at least one upper and the at least one lower guiding mechanisms are each linked about the vertical axis to the frame and the leaf.

### BACKGROUND

The present disclosure relates to a mounting unit for a window or a door. The mounting unit includes a frame on which a leaf is held. The leaf is movable from a closed position by at least one curved guiding mechanism into a parallel knockout position. The leaf is pivotable from the parallel knockout position about a vertical axis into a rotary opening position.

From German Patent Document DE 10113597, a mounting unit for a window or a door is known, in which a leaf can first be moved into a knockout position in order to then be pivoted from this knockout position into a rotary opening position. For the parallel knockout of the leaf, connecting link guides are provided, while the pivoting takes place about a vertical axis which can be moved horizontally by the length of the knockout movement. This mounting unit is arranged such that, as a result of the fixed distance of the leaf from the axis of rotation at the frame, the leaf cannot be opened completely, that is, only at 90°. The opening angle can be slightly enlarged by corresponding contours of the frame and of the leaf which, however, does not reach the goal of the opening by 90° and additionally is visually a problem.

Furthermore, it had been suggested in the prior art to, on the one hand, permit a knockout of a window and, on the other hand, permit a rotary opening only from the closed position. However, this construction is poorly suitable for an automatic opening operation because two possible types of movements are available which first require a selection.

A mounting for a tilting-pivoting leaf with a scissors-type knockout arrangement is also known from German Patent Document DE 1 086 147. By use of the mounting, the window can optionally be brought into a tilting or rotary opening position.

Furthermore, a parallel knockout window with a rotary function is known from German Patent Document DE 19825071, in which a mounting element reaches angularly around a frame, a connecting link guide for the parallel knockout of the window being provided at the mounting element itself. These mounting elements are mounted on the frame from the outside and are therefore visually conspicuous. On the other hand, the mounting elements have to be guided through the sealing devices between the leaf and the frame. In addition, the mounting element itself acts as a cold bridge. This construction is not suitable for high-quality doors or windows.

### SUMMARY

The present disclosure relates to a mounting unit for a window or a door which permits a parallel knockout and a pivoting into a rotary opening position with a large opening angle in a compact construction.

The present disclosure includes a mounting unit for a window or a door, The mounting includes a frame and a leaf mounted on the frame. The leaf is movable from a closed position by at least one curved guiding mechanism into a parallel knockout position. The leaf is also pivotable from the parallel knockout position about a vertical axis into a rotary opening position. At least one upper horizontal guiding mechanism is provided on a top side of the leaf and at least one lower horizontal guiding mechanism is provided on a bottom side of the leaf. The at least one upper and the at least one lower horizontal guiding mechanisms are configured to guide the leaf. In a closed position of the leaf, the at least one upper and the at least one lower horizontal guiding mechanisms are arranged inside the frame. The at least one upper and the at least one lower guiding mechanisms are each linked about the vertical axis to the frame and the leaf is rotatably held on a pin spaced-apart from at least one of the at least one upper and lower horizontal guiding mechanisms.

According to the present disclosure, the leaf is held on a frame for guiding the leaf and at least one upper horizontal guiding mechanism is provided on a top side of the leaf and at least one lower horizontal guiding mechanism is provided on an underside of the leaf. The at least one upper and lower horizontal guiding mechanisms are arranged inside the frame in the closed position of the leaf. As a result, no mounting parts protrude beyond the leaf or the frame in the closed position. Therefore, a good heat insulation and a compact construction are achieved. Furthermore, as a result of the horizontal guiding mechanisms, a stable guidance of the leaf is achieved which can be moved into a rotary opening position with a large opening angle. The term “pivoting” comprises any rotational movement, in which case another relative movement of the leaf with respect to the axis of rotation may exist.

The upper and the lower guiding mechanisms are each linked to the frame about a vertical axis, so that the corresponding mounting parts can be mounted on an interior side of the frame. The upper guiding mechanism then extends at least partially along the top side of the leaf, and the lower guiding mechanism extends at least partially along the underside of the leaf, so that the guiding mechanisms are not visible in the closed position and appear only during the pushing-out and pivoting of the leaf.

According to an embodiment of the present disclosure, a vertical axis passes through a space between the frame and the leaf. It will then be able for the leaf to move away relative to the vertical axis during the pivoting in the opening direction, so that, during the pivoting, the leaf does not strike against the frame and a maximal opening position is limited.

In order to move the leaf slightly away from the axis of rotation during the pivoting, an additional guiding mechanism can be guided on the frame at least on the upper side. The additional guiding mechanism is connected with the other guiding mechanism in a hinged manner. The leaf can be at least partially held on the additional guiding mechanism, so that a defined pivoting movement takes place during the opening. In this case, the additional guiding mechanism is guided with one end on the frame and is linked to the guiding mechanism on the opposite side. A linking of the guiding mechanism is provided between a fastening point for the leaf and the guidance in the frame. The distance between the linkage of the guiding mechanism and the fastening point for the leaf can be utilized for removing the leaf during the pivoting in the opening direction from the axis of rotation of the guiding mechanism. Thus, a larger maximal opening position can be achieved than would be possible without a corresponding radial movement.

In order to avoid damage caused by an excessive opening of the leaf, an opening limit is provided. As a result, the mounting unit is also suitable for an automatic operation. The opening limit has two arms which are hinged to one another and whose pivoting capacity relative to one another is limited by a stop. As a result, the opening limit can be mounted on a relatively small space. As an alternative, the displacement of an additional guiding mechanism can be selected as an opening limit, which would then require slightly more space.

According to another embodiment of the present disclosure, a leaf lifter is mounted in the area of the axis of rotation of the lower guiding mechanism on the frame in order to introduce the weight of the leaf into the frame. For this purpose, the leaf lifter may have an angular construction and by a leg reach under the leaf, a stable supporting takes place. A second leg can be fastened laterally to the leaf. In this case, a certain elasticity will then exist so that the knockout movement of the leaf is compensated by a warping of the upper leg. In this case, the leaf lifter can also be slightly tipped laterally so that the leaf is always securely held even during an adjusting movement of the leaves.

Further, to obtain a compact construction, corner deflections can be provided on the side of the leaf situated opposite the vertical axis, on which corner deflections one radial cam respectively is mounted for the parallel pushing-out of the leaf.

Other aspects of the present disclosure will become apparent from the following descriptions when considered in conjunction with the accompanying drawings.

### BRIEF DESCRIPTION OF THE DRAWINGS

FIG. 1 is a front view of a mounting unit, according to the present disclosure, in a mounted condition.

FIGS. 2A and 2B are two views of a curved guiding mechanism of the mounting unit of FIG. 1.

FIG. 3 is a top view of an upper area of the mounting unit of FIG. 1, about a vertical axis of rotation.

FIG. 4 is a top view of an upper area of another embodiment of a mounting unit, about a vertical axis of rotation, according to the present disclosure.

FIG. 5A is a lateral view of the upper area of the mounting unit of FIG. 4.

FIG. 5B is a sectional view of a leaf and a frame of FIG. 4.

FIG. 6A is a top view of an upper area of the mounting unit of FIG. 5A.

FIG. 6B is a sectional view of a frame and a leaf of FIG. 6A.

FIG. 7 is a top view of the mounting unit of FIG. 4 in an upper area of an axis of rotation, similar to FIG. 6A, but in a knockout position.

FIG. 8 is a top view of the mounting unit of FIG. 4 in a lower area adjacent to an axis of rotation.

FIG. 9 is a top view of an upper area of the mounting unit of FIG. 4 adjacent to an axis of rotation, in an opened position.

FIG. 10 is a front view of the mounting unit of FIG. 4 in a lower area adjacent to the axis of rotation, in a closed position.

### DETAILED DESCRIPTION

A mounting unit is mounted on a frame 1 having a leaf 2. The leaf 2 is movable from the frame 1 first into a parallel moved-out position and then into a rotary opening position. The leaf 2 can be pivoted about a vertical axis 3.

A handle 5, which moves a connecting rod mounting 6 via a gearing 4, is provided for moving the leaf 2. The connecting rod mounting 6 is connected with an upper and a lower curved guiding mechanism 8 via corner deflections 7. Adjacent to the curve guiding mechanism 8, another connecting rod mounting 9 is provided which is connected with a curved guiding mechanism 10 in order to ensure a parallel pushing-out of the leaf 2 in an area of the axis 3 of rotation.

In the closed position of the leaf 2, the handle 5 is oriented downward. A maximal parallel knockout position of the leaf 2 is reached during a pivoting of the handle 5 in an upward position via a horizontal position into a diagonal position just before a perpendicular position. If the handle 5 is rotated still farther into the upward-oriented position, the leaf 2 is released at the curve guiding mechanisms 8 and can thus be pivoted about the vertical axis 3. For this purpose, an upper knockout device 11 and a lower knockout device 12 are provided, which are further explained herein.

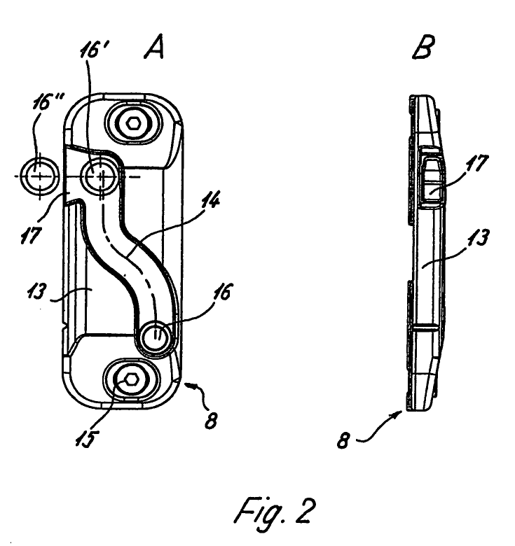

FIGS. 2A and 2B show the curved guiding mechanism 8. The curved guiding mechanism 8 comprises a basic body 13 in which a groove-shaped radial cam 14 is recessed. The basic body 13 is fastened to the leaf 2 via screws 15 and is mounted on a connecting rod mounting 9 or on the corner deflection 7. A pin 16 is fastened on the frame 1. It is also conceivable to connect the pin 16 with the connecting rod mounting 9 or the corner deflection 7 of the leaf 2 and to mount the basic body 13 on the frame 1.

The pin 16 moves in the radial cam 14 and is arranged in the lower position when the leaf 2 is closed. When the pin is moved into position 16′, the leaf 2 is in the maximally pushed-out position. In this position, the pin 16′ is arranged at a mouth 17 and can leave the curve guiding mechanism 8. In position 16″, the pin is situated outside the basic body 13, and the leaf 2 is in a rotary opening position.

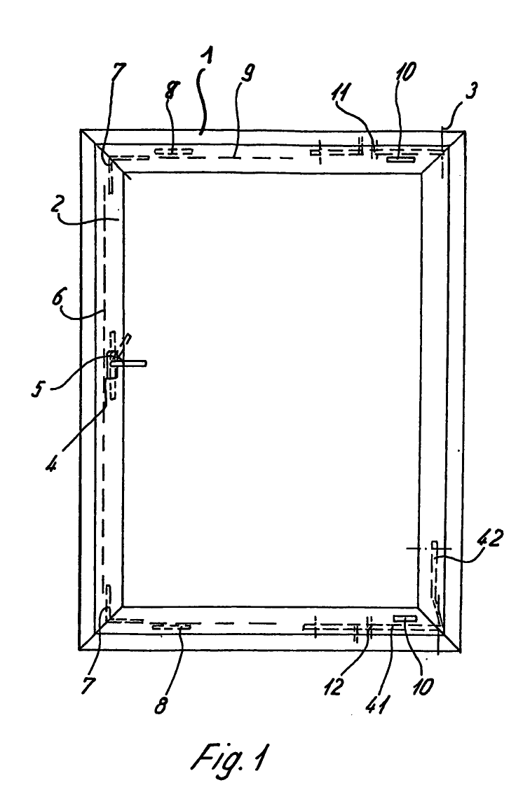

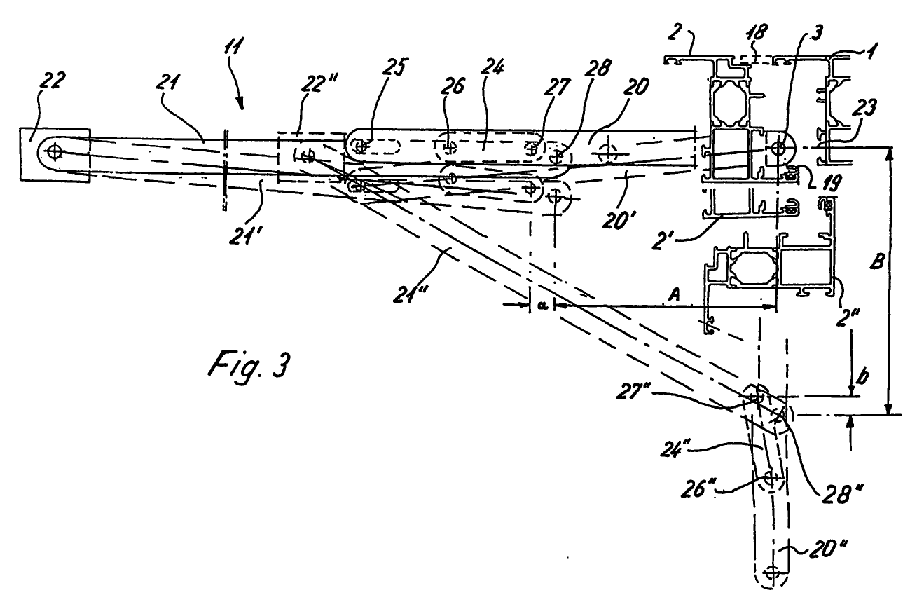

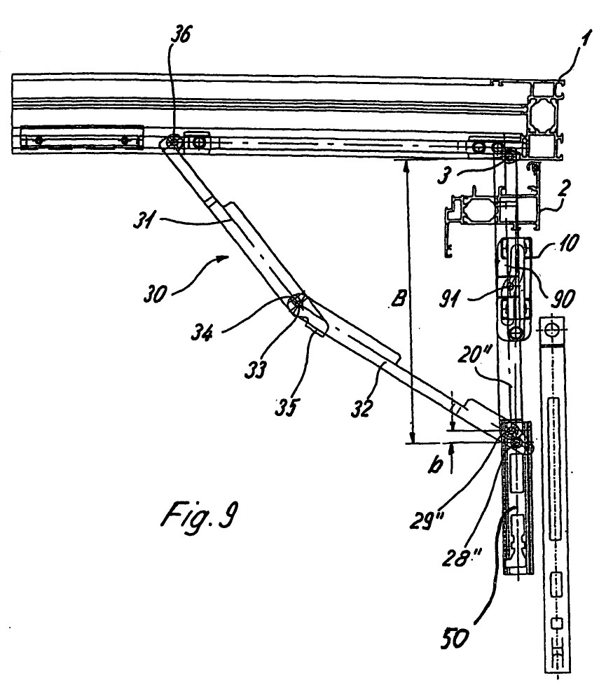

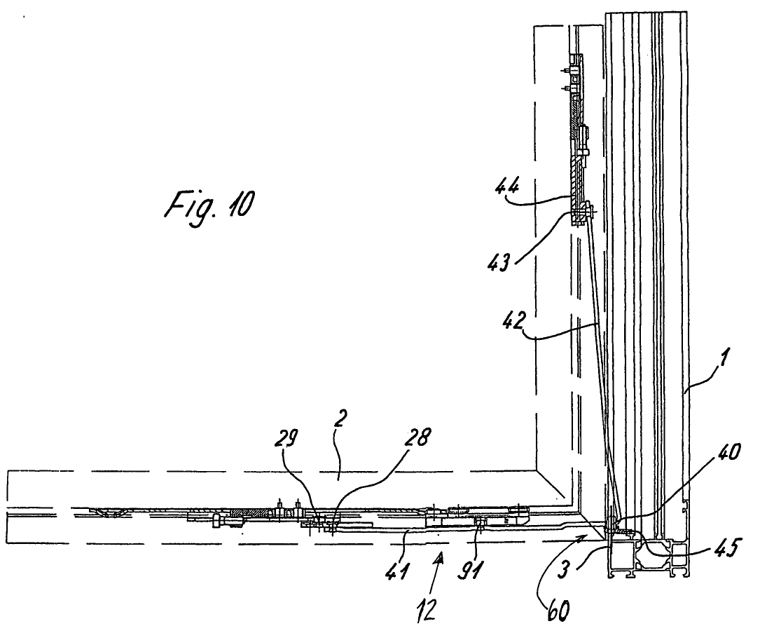

FIG. 3 is a top view of an upper area of the mounting unit of FIG. 1. For guiding the leaf 2, a guiding mechanism 20 is provided which can be rotated about vertical axis 3. For a better overview, the frame 1 is illustrated to be slightly removed from the leaf 2. A web 18 rests on the leaf 2 and, on an opposite interior side, a sealing device 19 on the leaf 2 rests on the frame 1. On the opposite side, the guiding mechanism 20 is connected via an oblong hole with a bolt 25 which is disposed in a housing 50 illustrated in FIG. 9. The housing 50 itself is anchored in a positionally fixed manner in a mounting receiving groove of the leaf 2.

An auxiliary guiding mechanism 24 is mounted on the guiding mechanism 20 at pin 26 and, at an axis or pin 27, is hinged to an additional guiding mechanism 21. The additional guiding mechanism 21 is also linked via an axis or pin 28 to the housing 50 and is connected with the leaf 2. On an opposite side, a slide 22 is provided on the additional guiding mechanism 21, which slide 22 is movably disposed in a groove 23 on the frame 1.

For a parallel moving-out of the leaf 2, the leaf 2 is lifted off the frame 1 via the curve guiding mechanisms 8, 10 of the leaves 2, so that the leaf 2 reaches position 2′. In this position, the guiding mechanism 20 is in position 20′ and the additional guiding mechanism 21 is in position 21′. The leaf 2′ is held on the axis or pin 28 via the curved guiding mechanism 10 as well as by fastening devices. During movement from a closed position into an opened pivoting position 2″, the leaf 2 moves away relative to the axis 3 of rotation. The reason is that the leaf 2 is not mounted directly on the guiding mechanism 20 but on the axis or pin 28 of the additional guiding mechanism 21.

In the closed position, a distance A exists between the axis or pin 28 and the axis 3 of rotation, and a distance equal to a exists between axis or pin 27 and axis or pin 28. In the opened position, the axis or pin position 27″ is situated closer to the axis or pin 3 of rotation than the axis or pin 28″, the radial distance between the axes 27″ and 28″ amounting to b. The distance between the axis 3 of rotation and the axis 28″ is marked as B. The following geometrical relationship is obtained on the basis of the linkage of the guiding mechanisms: B=A+a+b.

In other words, during a pivoting, the leaf 2 is moved by the length a+b farther away from the axis 3 of rotation. The leaf 2 is prevented from resting via sealing device 19 or a corresponding contact edge against the frame 1 and the maximal opening position is limited. In the illustrated embodiment of FIG. 3, the maximal opening position is reached when, in position 22″, the slide 22 rests against a stop and therefore no further pivoting movement of the leaf 2 can be carried out.

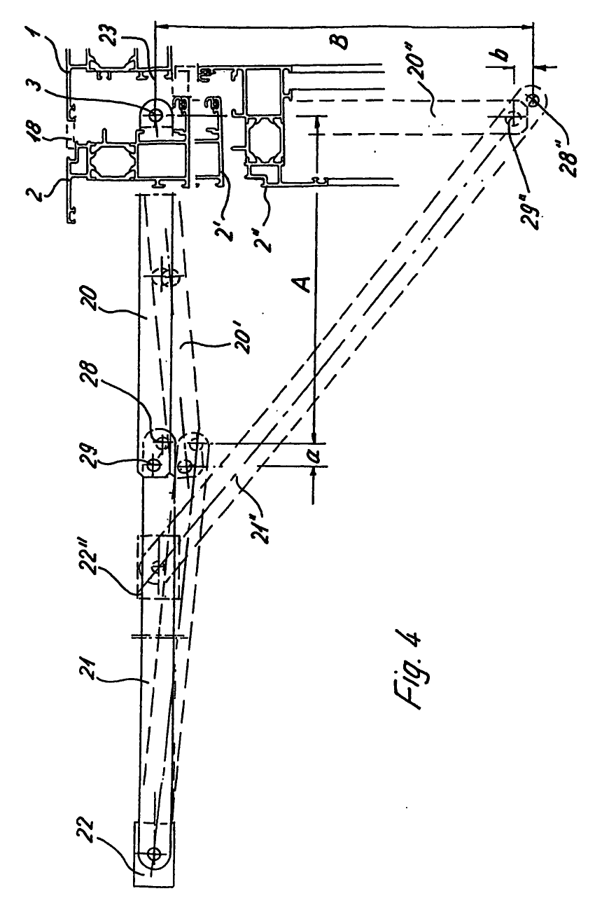

In an alternative embodiment illustrated in FIG. 4 for an upper knockout device 11 (see FIG. 5A) in the area of the axis 3 of rotation, an auxiliary guiding mechanism 24, as shown in FIG. 3, is omitted. A guiding mechanism 20 is disposed on an axis or pin 3 of rotation fixed to the frame 1 and is connected with an additional guiding mechanism 21 via axis or pin 29. The additional guiding mechanism 21 is situated above a slide 22 which is held in a groove (see axis 23) on the frame 1. Furthermore, axis or pin 28 is provided on the additional guiding mechanism 21, on which axis the leaf 2 is disposed via housing 50. In addition, the leaf 2 is also disposed on a curved guiding mechanism not shown, on the guiding mechanism 20.

For an opening of the leaf 2, the leaf 2 is first moved into parallel pushed-out position 2′. Subsequently, the leaf 2 is opened and pivoted into position 2″, the slide 22 being moved into the opening position 22″ to a stop. The additional guiding mechanism 21 moves to position 21″, then projects diagonally and holds the leaf 2″ on the axis or pin 28″.

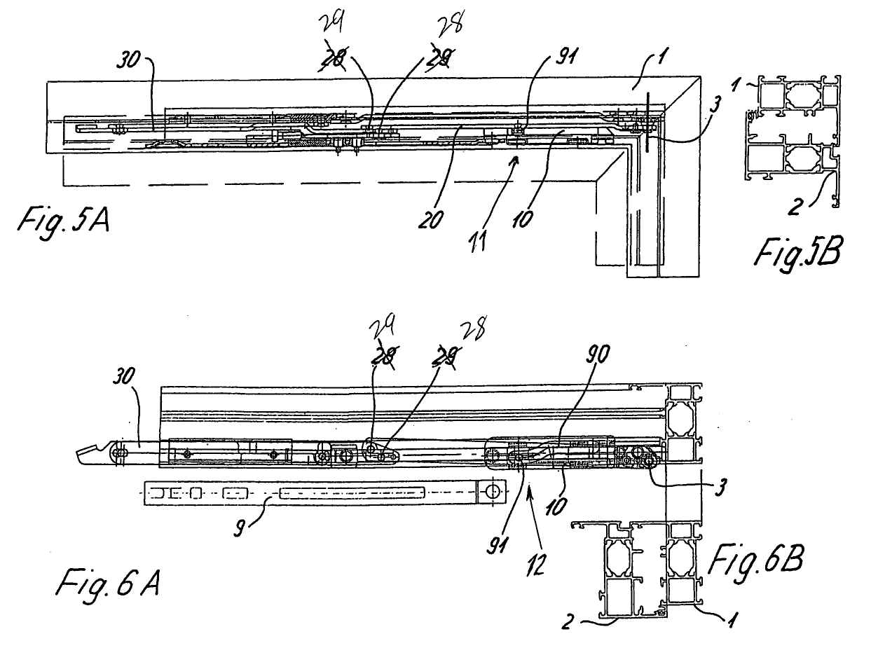

FIG. 5A shows the knockout device 11 according to FIG. 4, but viewed on a plane of the leaf 2. The guiding mechanism 20 is fastened to the axis 3 of rotation and is connected with an additional guiding mechanism 30 via axis or pin 28, which additional guiding mechanism 30 is used as a pivot limiting device. The leaf 2 is held on the additional guiding mechanism 30 on an axis or pin 29. Furthermore, a pin 91 is provided on the guiding mechanism 20, which pin 91 engages in a radial cam 90 of curved guiding mechanism 10 which is displaceably disposed on the leaf 2. In contrast to the curved guiding mechanism 8 of FIG. 2A arranged on the side of the handle 5, the radial cam 90 has a closed design and only permits the pin 91 to carry out a sliding motion. The shape of the radial cam 90 is illustrated in FIG. 6A.

FIG. 7 shows an upper part of the mounting unit of FIG. 5A, similar to FIG. 6A, but in a maximally parallel moved-out position of the leaf 2. The pin 91 has moved in the radial cam 90, and the leaf 2 has moved correspondingly. For reasons of clarity, the connecting rod 9 is illustrated at a distance from the curve guiding mechanism 10.

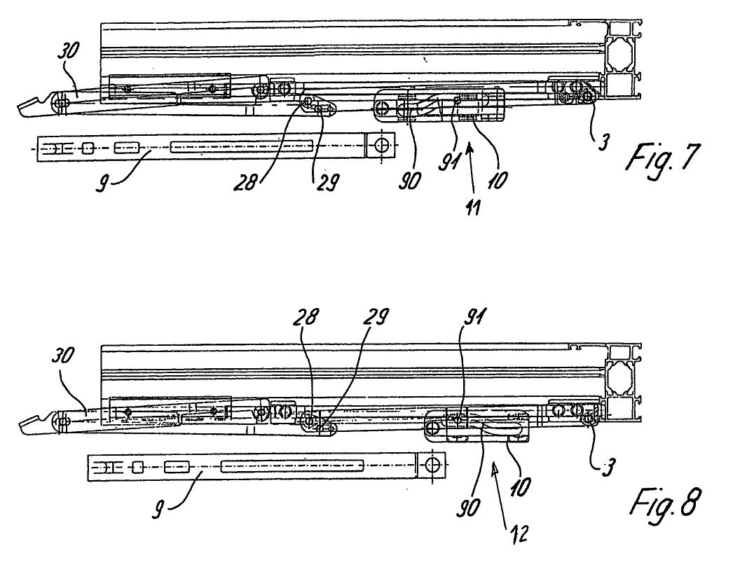

FIG. 8 shows the knockout device 12 in a lower area of the leaf 2. The curved guiding mechanism 10 was moved via stationary control pin 91 and thereby caused the parallel pushing-out of the leaf 2.

FIG. 9 shows the leaf 2 in the opened position. In this embodiment, the illustrated knockout device is arranged at a top side on the leaf 2 but, can also be mounted on a bottom side. The guiding mechanism 20″ is connected via axis or pin 29″ with an additional guiding mechanism 30 which also has the effect of a limit for the pivoting-out motion. For this purpose, the additional guiding mechanism 30 has a two-part construction including a first lever 31 and a second lever 32 which are mutually connected via axis or pin 33, the pin 33 being held in an oblong hole 34 of the lever 31. The lever 31 is rotatably fixed on a pin 36 on the frame 1. On the lever 32, the guiding mechanism 20″ is fixed to the pin 29″, while the leaf is held on a pin 28″.

The opening position of the leaf 2 is limited in that a stop 35 is molded to the lever 31, which stop 35 permits a maximal angle of the levers 31 and 32 of less than 180°. As a result, the leaf 2 cannot jam even in an automatic operation. For closing the leaf 2, the two levers 31 and 32 are folded over one another, so that the space requirement for the additional guiding mechanism 30 and the limit for the pivoting-out motion is kept comparatively low.

FIG. 10 illustrates a lower knockout device 12 in a view on a plane of the leaf 2. In the area of the axis 3 of rotation, a leaf lifter 60 is provided which, via a first horizontal leg 41 of the leaf lifter 60, reaches under the leaf 2 and, via a second leg 42 of the leaf lifter 60, is laterally fixed to the leaf 2. The horizontal leg 41 corresponds to guiding mechanism 20. For this purpose, second or upper leg 42 is fastened via pin 43 to an adjusting mounting 44 on the leaf 2.

The leaf lifter 60 is fastened on the frame 1 via pin 40 which forms the axis 3 of rotation. In the area of the axis 3 of rotation, a bearing disk 45 is provided below the leaf lifter 60, so that a weight of the leaf 2 can be carried off to the frame 1.

The leaf lifter 60 has no pivot about a horizontal axis. But, as a result of the lower leg 41, which also acts as a guiding mechanism, a warping of the leg 41 takes place which is supported on the bearing disk 45 by its edges during the parallel moving-out of the leaf 2 and, in the process, compensates for a measurement component which is the result of the tilting of the leaf lifter 60 during the parallel moving-out. In addition, starting from the adjusting mounting 44, the leaf lifter 60 is shaped and constructed diagonally downward to the frame 1 in order to introduce the weight of the leaf 2 into a frame corner. A length of the leaf lifter 60 is selected to be relatively large because this leaf lifter 60 has to compensate a lifting-off movement of the leaf 2 from the frame 1 during the rotary opening by a deformation.

In the preceding embodiments, guiding mechanism 20 was illustrated in which at least one additional guiding mechanism 21, 30 is mounted. That was in order to dispose the leaf 2 on the additional guiding mechanism 21, 30 and thereby achieve a relative movement away from the axis 3 of rotation of the guiding mechanism 20 during the pivoting of the leaf 2 out of the pushed-out position. This additional guiding mechanism 21, 30 is stable and can easily be placed in a space between the leaf 2 and the frame 1, so that it is not visible from the outside. However, it is also conceivable that, instead of the illustrated additional guiding mechanisms 21, 30, other mechanisms can be used which permit a pivoting of the leaf from the pushed-out position.

Although the present disclosure has been described and illustrated in detail, it is to be clearly understood that this is done by way of illustration and example only and is not to be taken by way of limitation. The scope of the present disclosure is to be limited only by the terms of the appended claims.

1. A mounting unit for a window or a door, comprising:
a frame;
a leaf mounted on the frame, the leaf being movable from a closed position by at least one curved guiding mechanism into a parallel knockout position and the leaf being pivotable from the parallel knockout position about a vertical axis into a rotary opening position;
at least one upper horizontal guiding mechanism on a top side of the leaf and at least one lower horizontal guiding mechanism on a bottom side of the leaf, the at least one upper and the at least one lower horizontal guiding mechanisms configured to guide the leaf, and in a closed position of the leaf, the at least one upper and the at least one lower horizontal guiding mechanisms are arranged inside the frame; and
the at least one upper and the at least one lower guiding mechanisms are each linked about the vertical axis to the frame and the leaf is rotatable held on a pin spaced-apart from at least one of the at least one upper and lower horizontal guiding mechanisms.

2. The mounting unit according to claim 1, wherein the at least one upper horizontal guiding mechanism extends at least partially along the top side of the leaf and the at least one lower horizontal guiding mechanism extends at least partially along the bottom side of the leaf.

3. The mounting unit according to claim 1, wherein the vertical axis extends through a space between the frame and the leaf.

4. The mounting unit according to claim 1, wherein the leaf moves away relative to the vertical axis during a pivoting into the rotary opening direction.

5. The mounting unit according to claim 1, further including an additional guiding mechanism which is hinged to at least one of the upper and lower horizontal guiding mechanisms and is guided on at least an upper side of the frame.

6. The mounting unit according to claim 5, wherein the leaf is held at the additional guiding mechanism and at at least one of the upper and lower horizontal guiding mechanisms to permit a pivoting movement.

7. The mounting unit according to claim 5, wherein one end of the additional guiding mechanism is guidably corrected to the frame, the leaf is connected at an opposite end of the additional guiding mechanism, and at least one of the upper and lower horizontal guiding mechanisms is connected to the opposite side of the additional guiding mechanism at a point between the connection to the frame and the connection to the leaf.

8. The mounting unit according to claim 1, wherein an opening limit is provided to limit the pivotable movement of the leaf.

9. The mounting unit according to claim 8, wherein the opening limit includes mutually hinged arms whose pivoting capacity relative to one another is limited by a stop.

10. The mounting unit according to claim 1, wherein in an area of the vertical axis of rotation of the at least one lower guiding mechanism, a leaf lifter is mounted on the frame in order to introduce the weight of the leaf into the frame.

11. The mounting unit according to claim 10, wherein the leaf lifter has an angular construction and guides and supports the leaf by a first leg and is fixed laterally to the leaf by a second leg.

12. The mounting unit according to claim 10, wherein the leaf lifter has an elastic construction and is held on a pin at the frame.

13. The mounting unit according to claim 1, further including corner deflections on the leaf at a side opposite the vertical axis, on which corner deflections a curved guiding mechanism is mounted for a parallel moving-out of the leaf.

14. The mounting unit according to claim 13, wherein the curved guiding mechanism is configured to be uncoupled for a pivoting of the leaf.

15. The mounting unit according to claim 1, further including a curved guiding mechanism on the leaf on a side of the vertical axis, and a pin is permanently engaged at the curved guiding mechanism in a closed radial cam.
